(19) United States
(12) Patent Application Publication
(10) Pub. No.: US 2018/0337758 A1
(43) Pub. Date: Nov. 22, 2018

(54) Systems And Methods For Scheduling Of Resources And Pilot Patterns To User Terminals In A Multi-User Wireless Network

(71) Applicant: HUAWEI TECHNOLOGIES CO., LTD., Shenzhen (CN)

(72) Inventors: Nassar KSAIRI, Boulogne Billancourt (FR); Stefano TOMASIN, Munich (DE); Beatrice TOMASI, Munich (DE)

(21) Appl. No.: 16/051,958

(22) Filed: Aug. 1, 2018

Related U.S. Application Data
(63) Continuation of application No. PCT/EP2016/052202, filed on Feb. 2, 2016.

(51) Int. Cl. H04L 5/00; H04L 27/26; H04B 17/309; H04L 25/02

(52) U.S. Cl. CPC H04L 5/0048; H04L 25/0204; H04B 17/309; H04L 27/2613

(57) ABSTRACT

A first apparatus used in a wireless network for scheduling of resources to user terminals, comprises a receiver adapted to receive wirelessly a plurality of transmission signals from a plurality of user terminals over a plurality of channels, and a processing unit adapted to assigning at least one of the plurality of user terminals to a resource block from a plurality of resource blocks according to at least one statistical channel feature of the respective channel from the plurality of channels which is used by respective the user terminal.

### CROSS-REFERENCE TO RELATED APPLICATIONS

This application is a continuation of International Application No. PCT/EP2016/052202, filed on Feb. 2, 2016. The disclosures of the aforementioned applications are hereby incorporated by reference in their entireties.

### BACKGROUND

The present invention, in some embodiments thereof, relates to multi-user wireless communication systems and, more specifically, but not exclusively, to resource allocation in multi-user wireless communication systems.

Wireless communication systems serve multiple users using wireless communication technologies such as orthogonal frequency division multiplexing (OFDM), single carrier frequency division multiple access (SC-FDMA), and multiple-input-multiple-output (MIMO). In such systems, multiple user terminals transmit over different channels to a single receiver. To perform coherent demodulation and correctly extract the transmitted data from the received carrier signal, the transmitters of the user terminals and the receiver of the wireless network need to be matched to each other. Training sequences are transmitted by each user terminal to allow the receiver to correctly demodulate the received signals. The resources (e.g., time/frequency/space) devoted to the training sequence transmission are subtracted from those available for data transmission. Therefore, having longer training sequences yields a reduction of the spectral efficiency and ultimately of the achievable data rates available to the user terminals.

### SUMMARY

It is an object of the present invention to provide an apparatus, a system, a computer program product, and a method for scheduling of resources to user terminals in a wireless network.

The foregoing and other objects are achieved by the features of the independent claims. Further implementation forms are apparent from the dependent claims, the description and the figures.

According to a first aspect, a first apparatus used in a wireless network for scheduling of resources to user terminals, comprises: a receiver adapted to receive wirelessly a plurality of transmission signals from a plurality of user terminals over a plurality of channels; and a processing unit adapted to: assigning at least one of the plurality of user terminals to a resource block from a plurality of resource blocks according to at least one statistical channel feature of the respective channel from the plurality of channels which is used by respective the user terminal.

The apparatus, systems, and/or methods described herein reduce the overall overhead associated with transmission of training sequences (making available additional wireless resources for transmission of user data) without significantly impacting the quality of the wireless link (e.g. dropped calls, bandwidth, data transmission rate) of the user terminals, which improves spectral efficiency of the wireless communication system. Users using different channels having diverse channel conditions may be provided with quality wireless communication services in an efficient manner.

In a first possible implementation of the first apparatus according to the first aspect, the assigning comprises: selecting for each one of the plurality of user terminals a pilot symbol pattern from a plurality of pilot symbol patterns according to respective the statistical channel features, the pilot symbol pattern entailing a corresponding pilot symbol overhead equal to the number of pilot symbols in the selected pilot symbol patterns; assigning each one of the plurality of user terminals to a resource block from the plurality of resource blocks according to a plurality of criteria, including at least the minimization of the pilot symbol overhead; setting the pilot symbol pattern for each one of the plurality of resource blocks as the pilot symbol pattern with maximum the pilot symbol overhead among the pilot symbol patterns selected for respective user terminals which are assigned to the resource block from the plurality of user terminals.

The apparatus, systems, and/or methods described herein increase the number of users that may be assigned to the same resource block, which improves utilization of wireless resources, such as in cellular systems that includes base stations with a large number of antennas that are used for spatial multiplexing of user terminals. The number of users assigned may be increased without necessarily significantly increasing the overhead of the pilot symbol patterns, and/or without significant reduction in the quality of the wireless communication link.

In a second possible implementation form of the first apparatus according to the first aspect as such or according to any of the preceding implementation forms of the first aspect, by the selecting, for each one of the plurality of user terminals, the pilot symbol pattern from a plurality of pilot symbol patterns, the plurality of user terminals are divided into a plurality of pilot pattern groups according to respective the statistical channel features; further comprising allocating a common pilot pattern to all members of each the plurality of pilot pattern groups.

Different user terminals which may have different needs in terms of the density of pilot symbols required for quality wireless communication over their respective channels (which may have different statistical channel features) may be assigned to different pilot pattern groups such that similar user terminals using channels with similar statistical features are assigned to the same group, which improves resources utilization for the group of user terminals.

In a third possible implementation form of the first apparatus according to the first aspect as such or according to the second preceding implementation form of the first aspect, assigning the plurality of user terminals to a resource block from the plurality of resource blocks is such that respective user terminals in the same resource block are selected from the same pilot pattern group and have the same pilot symbol pattern.

Grouping user terminals together reduces the average overhead required for all user terminals, improving utilization of the wireless resources, such as use of the available wireless spectrum.

In a fourth possible implementation form of the first apparatus according to second preceding implementation form of the first aspect, the division of user terminals to a plurality of pilot pattern groups is done by quantizing at least one of the statistical channel features of the respective channels which are used by the user terminals.

Grouping by statistical channel features improves utilization of the wireless resources, by reducing the maximum overhead required for the group, such as by excluding outlier user terminals and/or outlier channels, for example, users located at the edge of the cell or users moving at relatively high speeds with respect to the base station.

In a fifth possible implementation form of the first apparatus according to second and fourth preceding implementation forms of the first aspect, the division of user terminals to a plurality of the pilot pattern groups and the quantization of statistical channel features is done according to the number of the resource blocks which are available for wireless transmission.

The assignment of different pilot patterns of the different pilot pattern groups to different resource blocks makes it less likely that the same pilot pattern will be used on the same resource block in two neighboring cells, which improves efficiency of the wireless communication network by reducing the risk of interference.

In a sixth possible implementation form of the first apparatus according to second preceding implementation form of the first aspect, the first apparatus further comprises a transmitter adapted to transmit instructions to all members of one of the plurality of pilot pattern groups to use a common pilot pattern.

In a seventh possible implementation form of the first apparatus according to second preceding implementation form of the first aspect, the common pilot pattern is an OFDM pilot pattern and the resource block is an OFDM resource block.

In an eighth possible implementation form of the first apparatus according to the first aspect as such, each one of the plurality of user terminals transmits one of the plurality of transmission signals via a single antenna or multiple antennas.

In a ninth possible implementation form of the first apparatus according to the first aspect as such, the at least one statistical channel feature comprises at least one element of a list consisting of channel delay spread, channel maximum Doppler shift, channel spatial covariance matrix, channel matrix rank, channel average signal-to-noise ratio (SNR), and the history of ACK/NACK messages.

According to a second aspect, a method for performing resource assignment to user terminals, comprises: wirelessly receiving a plurality of transmission signals from a plurality of user terminals over a plurality of channels; and assigning each one of the plurality of user terminals to a resource block from a plurality of resource blocks according to at least one statistical channel feature of a respective channel used by respective the user terminal from the plurality of channels.

In a first possible implementation of the method according to the second aspect, the assigning comprises: selecting for each one of the plurality of user terminals a pilot symbol pattern from a plurality of pilot symbol patterns according to respective the statistical channel features, the pilot symbol pattern entailing a corresponding pilot symbol overhead equal to the number of pilot symbols in the selected pilot symbol patterns; assigning each one of the plurality of user terminals to a resource block from the plurality of resource blocks according to a plurality of criteria, including at least the minimization of the pilot symbol overhead; setting the pilot symbol pattern for each one of the plurality of resource blocks as the pilot symbol pattern with maximum the pilot symbol overhead among the pilot symbol patterns selected for respective user terminals which are assigned to the resource block from the plurality of user terminals.

In a second possible implementation form of the method according to the second aspect as such or according to any of the preceding implementation forms of the second aspect, by the selecting, for each one of the plurality of user terminals, the pilot symbol pattern from a plurality of pilot symbol patterns, the plurality of user terminals are divided into a plurality of pilot pattern groups according to respective the statistical channel features; further comprising allocating a common pilot pattern to all members of each of the plurality of pilot pattern groups.

In a third possible implementation form of the method according to the second aspect as such or according to the second preceding implementation form of the second aspect, assigning the plurality of user terminals to a resource block from the plurality of resource blocks is such that respective user terminals in the same resource block are selected from the same pilot pattern group and have the same pilot symbol pattern.

According to a third aspect, a second apparatus for transmitting and/or receiving signals in a wireless network comprises: a look-up table storing a plurality of pilot symbol patterns; a receiver adapted to receive instructions from a first apparatus; a processing unit configured to select, based on the received instructions, a pilot symbol pattern from the plurality of stored pilot symbol patterns, the selected pilot symbol pattern being a common pilot symbol pattern used by a plurality of second apparatuses belonging to a pilot pattern group; and a transmitter configured to transmit to the first apparatus pilot symbols according to the selected pilot symbol pattern.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a wireless communication system that includes a multi-user wireless communication unit that schedules resources for multiple user terminals, in accordance with some embodiments of the present invention;

FIG. 2 is a flowchart of a method that schedules resources for multiple user terminals communicating with a multi-user wireless communication unit of a wireless communication system, in accordance with some embodiments of the present invention;

FIG. 3 is a flowchart of an exemplary method for assigning user terminals to resource blocks based on statistical cannel features of respective channels used by the user terminal, in accordance with some embodiments of the present invention;

FIG. 4 is a flowchart of a method implemented by a user terminal in response to receiving instructions from a multi-user wireless communication unit, in accordance with some embodiments of the present invention;

FIG. 5 is an example of an OFDM pilot pattern, in accordance with some embodiments of the present invention;

FIG. 6 is a block diagram depicting exemplary dataflow in a wireless communication system that does not yet include the systems and/or methods described herein, in accordance with some embodiments of the present invention;

FIG. 7 is a block diagram based on FIG. 6, depicting exemplary dataflow in a wireless communication system that includes the systems and/or methods described herein, in accordance with some embodiments of the present invention; and

FIG. 8 is a graph of results obtained from the calculated comparison simulation, in accordance with some embodiments of the present invention.

### DETAILED DESCRIPTION

The present invention, in some embodiments thereof, relates to multi-user wireless communication systems and, more specifically, but not exclusively, to resource allocation in multi-user MIMO wireless communication systems.

An aspect of some embodiments of the present invention relates to a multi-user wireless communication unit (e.g., included within a base station and/or radio access network) that wirelessly communicates with multiple user terminals (and/or methods implemented by the multi-user wireless communication unit and/or user terminals). The multi-user wireless communication unit assigns one or more of the user terminals (e.g., each user terminal) to a resource block according to criteria that include statistical channel feature(s) calculated for each channel used by the respective user terminal for wireless communication with the multi-user wireless communication unit. The training sequence density within the resource grid (also termed herein pilot symbol pattern or pilot pattern) of each resource block may be selected to reduce the overall overhead associated with transmission of the training sequences, while not significantly impacting the quality of the wireless communication link available to each user of the resource block. In this manner, the apparatus, systems, and/or methods described herein reduce the overall overhead associated with transmission of training sequences (making available additional wireless resources for transmission of user data) without significantly impacting the quality of the wireless link (e.g. dropped calls, bandwidth, data transmission rate) of the user terminals.

Pilot symbol requirements may be determined on a per-user basis, according to the statistical features of the actual channel used by each user terminal. User terminals are scheduled into resource blocks, with each resource block having a common pilot pattern used by all user terminals assigned to the resource block. Different resource blocks may be assigned different pilot patterns. The user terminals are assigned to the resource blocks, and/or the common pilot pattern is assigned to each resource block according to calculated channel statistics, to reduce the overall wireless transmission resources used for transmission of the respective pilot patterns. The multi-user wireless communication unit allows for reducing the wireless transmission resources (e.g., bandwidth) used for transmission of the respective common pilot pattern without significantly affecting the quality of the wireless link between respective user terminals and the multi-user wireless communication unit. Wireless communication resources that would otherwise be used for transmission of the pilot pattern become available for other uses, such as transmission of additional user data and/or voice calls.

The pilot pattern is selected to have a reduced length according to the statistical channel properties of the channel used by each user terminal, while meeting the requirements that all user terminals assigned to the same resource block use the same pilot sequence, in an efficient manner.

Optionally, a pilot symbol pattern is selected from multiple available pilot symbol patterns, for each user terminal according to the calculated channel features. The pilot symbol patterns differ in the amount of overhead, which is equal to the number of pilot symbols in each pilot symbol pattern. For example, denser pilot symbol patterns (i.e., with more pilot symbols per resource block) may be selected for a channel with a longer maximum delay spread and/or a larger maximum Doppler frequency shift relative to a channel with a shorter maximum delay spread and/or a smaller maximum Doppler frequency shift. Each resource block is associated with a different pilot symbol pattern. Each user terminal is assigned to a respective resource block according to the selected pilot symbol pattern of the user terminal, such that user terminals having the same or similar pilot symbol requirements are assigned to the same resource block.

Alternatively or additionally, the pilot symbol pattern is selected from multiple available symbol patterns for a resource block, which includes multiple user terminal members. The pilot symbol pattern for the respective resource block is selected based on the calculated channel features of each channel used by each user terminal member, according to the pilot symbol pattern with the maximum pilot symbol overhead (i.e., maximum number of pilot symbols) for one or more user terminal members. In effect, the pilot symbol pattern for the block is selected to allow quality wireless communication for the user terminal using the most problematic channel (e.g., noise, interference, mobility). For example, when there are 10 user terminal members in the resource block, with 9 channels having very small Doppler frequency shift, and 1 channel having excessive Doppler frequency shift, the pilot symbol pattern is selected for all members to be sufficiently dense (i.e., have a number of symbols per resource block) to allow quality wireless communication for the user terminal using the 1 problematic channel. It is noted that the user terminals selected for inclusion within the resource block may be first selected based on similar statistical channel features, for example, the 10 user terminal members in the resource block use channels with very small Doppler frequency shift, or the 10 user terminal members use channels with significant Doppler frequency shift. The pilot symbol pattern is then selected for all members in the resource block.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

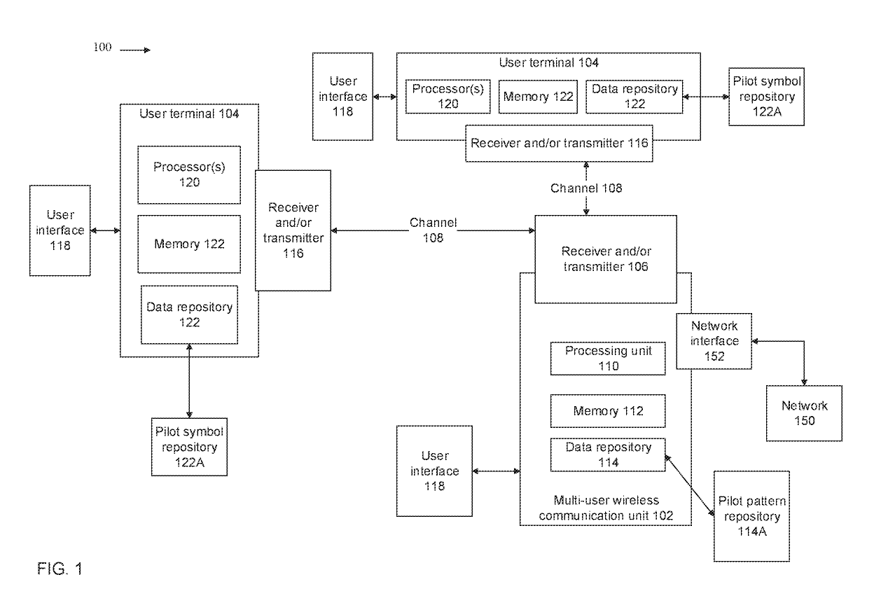

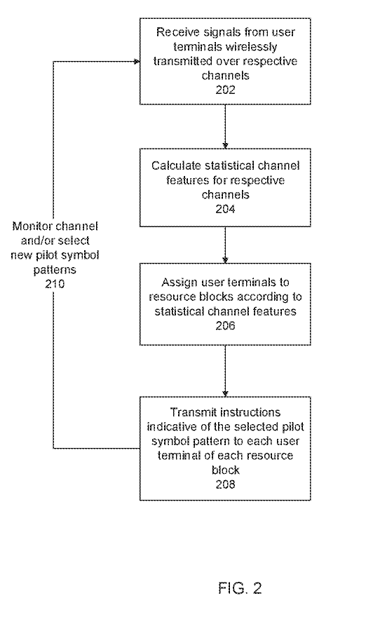

Reference is now made to FIG. 1, which is a block diagram of a wireless communication system 100 that includes a multi-user wireless communication unit 102 that schedules resources for multiple user terminals 104, in accordance with some embodiments of the present invention. Multi-user wireless communication unit 102 assigns each of user terminals 104 to one of multiple resource blocks according to statistical channel feature(s) of the respective channel used by the respective user terminal 104. The per user terminal assignment reduces the overhead of pilot symbol patterns that are used for coherent demodulation over the respective channel, while not significantly impacting the quality of wireless communication over the respective channel, which improves spectral efficiency of the wireless communication system 100. Reference is also made to FIG. 2, which is a method for scheduling resources for multiple user terminals communicating with a multi-user wireless communication unit of a wireless communication system, in accordance with some embodiments of the present invention. The method described with reference to FIG. 2 may be implemented by multi-user wireless communication unit 102 of system 100 described with reference to FIG. 1.

The apparatus, systems, and/or methods described herein increase the number of users that may be assigned to the same resource block, which improves utilization of wireless resources, such as in cellular systems that includes base stations with a large number of antennas that are used for spatial multiplexing of user terminals.

The number of users assigned may be increased without necessarily significantly increasing the overhead of the pilot symbol patterns, and/or without significant reduction in the quality of the wireless communication link. Users using different channels having diverse channel conditions may be provided with quality wireless communication services in an efficient manner.

Multiuser wireless communication unit 102 includes a receiver and/or transmitter 106 (e.g., transceiver) for receiving signals from and/or transmitting signals to multiple user terminals 104 over respective channels 108. Channels 108 may be implemented according to the implemented wireless communication protocol, for example, based on orthogonal frequency division multiplexing (OFDM), single carrier frequency division multiple access (SC-FDMA), and multiple-input-multiple-output (MIMO) based protocols. Receiver/transmitter 106 may be implemented as a single antenna, or multiple antennas.

Multi-user wireless communication unit 102 may be implemented, for example, within a base station, a transmission tower, a radio access network, or other network device that provides wireless communication services between user terminals 104 and a network 150, for example one or more of, the internet, a private network, a wireless cellular network, and a landline telephone network. Multi-user wireless communication unit 102 includes a network interface 152 for communicating with network 150.

Multi-user wireless communication unit 102 may be implemented for example, as a standalone computer, as a server, as a distributed system, as software installed on an existing device (e.g., base station equipment) and/or as a hardware card or other component attached or inserted into the existing equipment.

Multi-user wireless communication unit 102 includes a processing unit 110 (e.g., central processing unit(s), digital signal processing unit(s), field programmable gate array(s), customized circuit(s), processors for interfacing with other units, and/or specialized hardware accelerators (e.g., encoders, decoders, and cryptography co-processors)) which implement code stored in a memory 112 (and/or other local and/or external and/or remote storage device, e.g., hard drive, random access memory, optical drive, other storage devices).

Multi-user wireless communication unit 102 includes or is in communication with a data repository 114 that stores data, for example, a random access memory (RAM), read-only memory (ROM), and/or a storage device, for example, non-volatile memory, magnetic media, semiconductor memory devices, hard drive, removable storage, optical media (e.g., DVD, CD-ROM), a remote storage server, and a computing cloud.

Data repository 114 may store multiple pilot patterns for assignment to resource blocks (as described herein) within a pilot pattern repository 114A, for example, a database, a look-up table, or other formats.

User terminals(s) 104 may be stationary devices or mobile devices that include a receiver and/or transmitter 116 for communication with receiver and/or transmitter 106 of multi-user wireless computing unit 102. Receiver and/or transmitter 116 may be implemented using a single antenna or multiple antennas. Receiver and/or transmitter 116 may be integrated within user terminal 104 (e.g., within a mobile device) or may be an external device that can be attached and detached (or connected and disconnected) from user terminal 104, for example, a wireless modem, and a wireless connection stick. Exemplary user terminals 104 include: a computer, a server, a laptop, a mobile device, a Smartphone, a Tablet, a wearable computer, a watch computer, and a glasses computer.

Each user terminal 104 and/or multi-user wireless computing unit 102 may include or be in communication with a user interface 118 that allows a user to enter data and/or display (and/or hear) data, for example, one or more of: a touch-screen, a display, a radiology monitor, a keyboard, a mouse, voice activated software, and a microphone.

Each user terminal 104 includes a processing unit 120 (e.g., one or more central processing units), a memory 122 that stores program code for execution by processing unit 120, and a data repository 122 that stores data including a pilot symbol repository 122A that includes multiple available pilot symbols for use during wireless communication with receiver/transmitter 106 of multi-user computing unit 102. Pilot symbol repository 122A may be implemented, for example, as a look-up table, a database including entries, or other formats.

It is noted that two client terminals 102 are shown for clarity, but it is to be understood that greater numbers of user terminals 104 may communicate with a single multi-user wireless communication unit 102.

At 202, one or more of user terminals 104 transmits transmission signals via receiver/transmitter 116 (i.e., single antenna or multiple antennas). The transmission signals may include user data (e.g., voice data, and application related data) and/or pilot signals. Each user terminal 104 transmits over its respective channel 108, using a wireless communication link. The signals transmitted from user terminals 104 are received by receiver/transmitter 106 of multi-user wireless communication unit 102.

The pilot symbols of different user terminals 104 may overlap due to spatial multiplexing. Optionally, the pilot symbols do not overlap with data symbols.

Conditions of respective channels 108 used by different user terminals 104 may vary, for example, according to the power of the transmitter of the user terminal, the location and the velocity of the user terminal relative to the base station, interference, noise, environmental conditions (e.g., rain, snow) or other factors.

At 204, one or more statistical channel features are calculated. Statistical channel features may be calculated for each channel 108 of each user terminal 104 communicating with multi-user wireless communication unit 102. The statistical channel features are calculated by analyzing the signals received from each user terminal 104 over its respective channel 108, optionally within a period of time, for example, the last 10 milliseconds, or 5 milliseconds, or 1 second, or other values. The statistical channel features may be calculated by code stored in memory 112 executed by processing unit 110 of multi-user wireless communication unit 102.

The calculated channel features may be selected to represent the required pilot overhead of the wireless communication link over the respective channel 108, for example, in terms of the scale of time-domain and frequency-domain variations of the respective channel.

The channel features may be calculated from the transmitted user data (i.e., without the pilot signals) or from previously transmitted pilot signals. The channel features may not necessarily be used for beam forming, such as when the calculations are not based on the transmitted pilot signals. The channel features may be selected to allow grouping user terminals and/or selecting the pilot pattern for a group of user terminals, as described herein.

Exemplary channel features that may be calculated include one or more of:

Channel delay spread. For higher values of the channel delay spread, pilot signals with larger overheads (i.e., denser pilot symbols) may be selected (in the frequency dimension) to provide quality wireless communication.

Channel maximum Doppler shift. For smaller values of the maximum Doppler shift, pilot signals with smaller overheads (i.e., less dense pilot symbols) may be selected in the time domain.

Channel spatial covariance matrix. For lower-rank spatial covariance matrix values, pilot signals with smaller overheads may be selected.

Channel spatial covariance matrix rank.

Channel average signal-to-noise ratio (SNR). The SNR may be used to identify users that are located at the edges of the cell, for example, experiencing a pilot contamination phenomenon in a multicellular OFDM based massive MIMO system where each base station is equipped with a relatively large number of antennas.

The history of ACK/NACK messages.

At 206, one or more of the user terminals 104 is assigned to a resource block (from multiple resource blocks) according to one or more of the statistical channel feature calculated for the respective channel 108 which is used by the respective user terminal 104 in communicating with multi-user wireless communication unit 102. The assignment may be performed by code stored in memory 114 executed by processing unit 110.

User terminals 104 in the same resource block use the same pilot symbol pattern. The assigning may be performed such that respective user terminals 104 in the same resource block are selected from the same pilot pattern group, as described herein. Each pilot pattern group is assigned the same pilot symbol pattern.

The resource blocks may be defined by the wireless communication protocol implemented within system 100. The pilot patterns (of various symbol sequence lengths) may be defined by the wireless communication protocol implemented within system 100. Optionally, the (e.g., common) pilot pattern is an OFDM pilot pattern, and the resource block is an OFDM resource block.

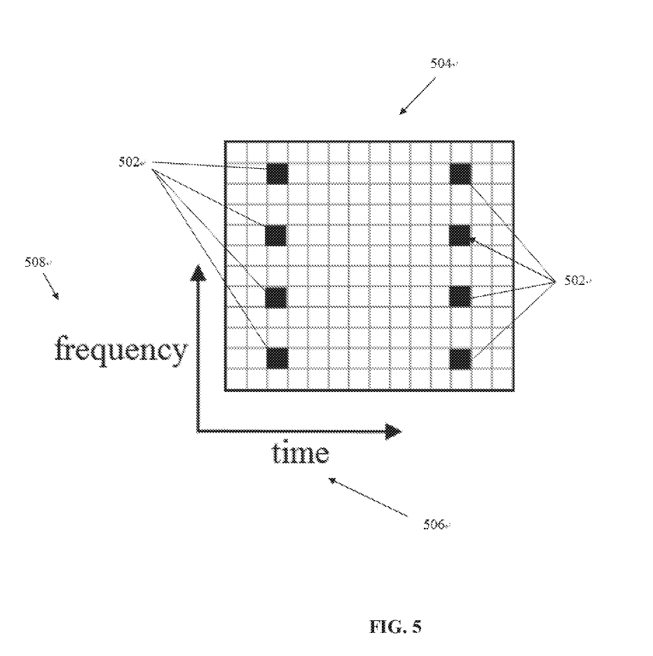

Reference is now made to FIG. 5, which is an example of an OFDM pilot pattern 502 (i.e., training symbol), in accordance with some embodiments of the present invention. Channel 504 is represented by a grid using a time axis 506 and a frequency axis 508. After OFDM demodulation, each square at a given time-frequency (also termed resource element or subcarrier) includes the quadrature amplitude modulation (QAM) transmitted symbol multiplied by a complex number representing the channel frequency response at that time (i.e., frame). Noise may also be added to each product. Pilot pattern 502 (represented as multiple black squares) are transmitted instead of data (represented as white squares) at predefined time-frequency positions within channel 504. Pilot pattern 502 may be defined by symbols that are periodic in time and/or frequency. Pilot patterns 502 having different overheads may be defined by the number of black squares along an axis. The length of the pilot pattern may be defined for each axis.

It is noted that other domains may be used as axes, as defined by different wireless transmission protocols. For example, a time/space axes may be used. Channel 504 may be used for uplink and/or downlink, for example, a downlink scenario where the multi-user communication unit applies a per-user terminal beamforming and each user terminal aims at estimating the resulting channel (e.g., the effective channel which is the cascade of beamforming and wireless channel).

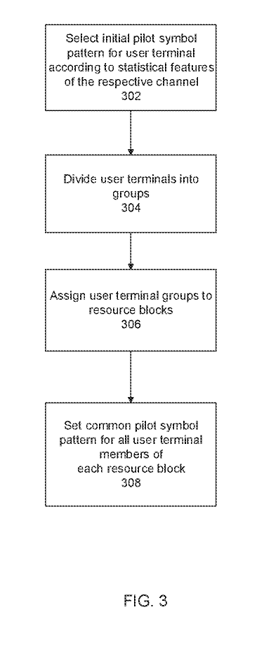

Reference is now made to FIG. 3, which is a flowchart of an exemplary method for assigning user terminals to resource blocks based on statistical cannel features of respective channels used by the user terminal, in accordance with some embodiments of the present invention.

At 302, an initial pilot symbol pattern is selected for each user terminal 104. The pilot symbol pattern may be selected according to statistical channel features calculated for the respective channel 108 used by each of the user terminals 104. The pilot symbol pattern may be selected for each user terminal 104, to allow quality wireless communication (e.g., defined by a quality requirement(s)) each user terminal 104 over its respective channel 108. The pilot symbol pattern may be selected independently for each user terminal 104.

The pilot symbol pattern may be selected from multiple available pilot symbol patterns, which may be stored in pilot pattern repository 114A. The pilot symbol pattern entails a corresponding pilot symbol overhead equal to the number of pilot symbols in the selected pilot symbol pattern. Pilot symbol patterns with different lengths are available for selection, for example, relatively longer patterns may be selected for problematic channels, for example, channels experiencing interference, noise, that travel through physical items other than air (e.g., buildings, mountains, trees), channels to/from user terminals moving at relatively high speeds, and longer channels (e.g., users far away from the base station).

The channel features may be arranged as a vector, which may be used to map to a pilot pattern suitable for the vector. The mapping may be performed by a mapping function, which may use a set of rules for the mapping. In another example, a trained statistical classifier may receive the channel features as inputs, and perform a mapping to the pilot pattern best suited for the channel features. The set of rules may be obtained, and/or the statistical classifier may be trained, for example, based on empirically collected data, and/or simulation calculated data.

At 304, user terminals 104 are divided into multiple pilot pattern groups. The division into groups may be performed according to the respective statistical channel features. For example, user terminals 104 that have similar statistical channel features within a tolerance requirement are grouped together. The division into groups may be performed according to the pilot symbol pattern selected for each user terminal 104. User terminals 104 that have the same pilot sequence patterns may be grouped together, or user terminals 104 that have similar pilot sequence patterns may be grouped together.

A common pilot pattern is allocated to all members of each pilot pattern group. The common pilot pattern is selected according to the statistical channel features of the group assigned to the resource block. Different user terminals which may have different needs in terms of the density of pilot symbols required for quality wireless communication over their respective channels (which may have different statistical channel features) may be assigned to different pilot pattern groups such that similar user terminals using channels with similar statistical features are assigned to the same group, which improves resources utilization for the group of user terminals.

Grouping user terminals together reduces the average overhead required for all user terminals, improving utilization of the wireless resources, such as use of the available wireless spectrum.

Optionally, the division of user terminals to pilot pattern groups is done by quantizing one or more of the statistical channel features of the respective channels which are used by the user terminals. The quantization may be performed using a linear scale, a logarithmic scale, an exponential scale, based on a Gaussian distribution, or other scales. The quantization may be performed for each statistical channel feature, for a set of statistical features (e.g., within a space having dimensions defined by the features), or for a value calculated as a composition of the statistical features (e.g., by a function). Grouping by statistical channel features improves utilization of the wireless resources, by reducing the maximum overhead required for the group, such as by excluding outlier user terminals and/or outlier channels, for example, users located at the edge of the cell or users moving at relatively high speeds with respect to the base station.

Optionally, the division of user terminals to pilot pattern groups and the quantization of statistical channel features is done according to the number of resource blocks which are available for wireless transmission. For example, when five resource blocks are available, the quantization is performed using 5 groups.

The assignment of different pilot patterns of the different pilot pattern groups to different resource blocks makes it less likely that the same pilot pattern will be used on the same resource block in two neighboring cells, which improves efficiency of the wireless communication network by reducing the risk of interference.

The quantization may be performed by a mapping function that maps the statistical features of each channel to one of the groups.

Optionally, the division of user terminal is performed based on the SNR statistical channel feature. The SNR may be used to represent the relative location of the user terminal to the cell edge or the cell center. User terminals at the cell edge may be grouped together, and assigned pilot patterns that are longer than the pilot patterns assigned to user terminals located closer to the cell center. Division based on SNR may be implemented, for example, in the case of a heterogeneous wireless cellular network composed of a macro cell mainly serving high-mobility users and a number of massive-MIMO small cells mainly serving quasi-static users. The channels of such low-mobility users are assumed to have similar channel statistical features so that the main potential reduction in pilot overhead for the small-cell users may be achieved by adapting the pilot patterns according to the vulnerability of the user terminals to pilot contamination.

At 306, each user terminal 104 is assigned to a resource block (from the multiple available resource blocks) according to one or more criteria, including at least the minimization of the pilot symbol overhead that is required to allow the user terminal to transmit over its channel, for example, at a predefined wireless transmission quality requirement, for example, in terms of dropped calls, error rates, effective user data transmission rates, effective bandwidth, and phone call quality.

The assignment may be performed based on the grouping of user terminals. Each group is assigned to a different resource block such that the pilot symbol overhead assigned to all members of the group is minimized, such as by selecting the user terminals having similar channel statistic features.

The assignment may be performed when the groups have already been defined, such as when a new user terminal is added. The new user terminal may be assigned to the resource block having an associated pilot sequence with a certain overhead, such that the minimum pilot symbol overhead is provided that allows quality wireless transmission over the channel used by the new user terminal.

At 308, the pilot symbol pattern is set for each resource block as the pilot symbol pattern with maximum pilot symbol overhead for the user terminals assigned to the resource block.

Optionally, user terminal members are assigned to the same resource block (regardless of the method of assignment) and have channels with statistical channel features that vary significantly between different channels used by different user terminals. In such a case, the most problematic channel is identified (e.g., the worst statistical values representing the lowest quality channel). The minimum pilot symbol overhead that is needed to allow quality wireless communication over the most problematic channel is identified. The determined minimum pilot symbol overhead for the problematic channel is used for all members of the group, since the other members, who use less problematic channels, when considered independently would be able to use shorter pilot symbol overheads. The determined minimum pilot symbol overhead for the problematic channel is the maximum pilot symbol overhead of the group of user terminals.

Optionally, when all user terminal members of the resource block have channels that have statistical channel features that do not vary significantly between different channels such that each user terminal considered alone would require a different length of pilot symbols, the minimum pilot symbol overhead is selected (since all user terminals considered independently would utilize the same minimum pilot symbol length). In such a case, the maximum pilot symbol overhead and the minimum pilot symbol overhead are the same, since all user terminals of the group have similar pilot symbol requirements based on similar statistical channel fields.

It is noted that all acts of FIG. 3 may be performed, or some acts may be omitted:

In one case, the user terminals are divided into groups and assigned to resource blocks based on channel statistical features. The maximum pilot symbol overhead is selected for each resource block (or group). In one example, the case is implemented by performing an exhaustive search among all possible pilot pattern group formations and user scheduling configurations to select which users to schedule on which resource block and what pilot pattern to use for each one of these resource blocks. Such a case may be implemented, for example, when the channel conditions and/or user requirements are diverse, and/or when sufficient computational resources are available to perform the division and pilot symbol selection.

In another case, the user terminals are divided into groups and assigned to resource blocks based on similar channel statistical features. Such a case may be implemented, for example, when the number of user terminals corresponding to each quantized channel condition i.e., the number of users in each pilot pattern group, is large and/or where the number of available pilot patterns is small.

In yet another case, the user terminals are divided into groups and assigned to resource blocks based on channel statistical features, such that all user terminals in the group have the same pilot symbol overhead requirements.

In yet another case, the user terminals are divided into groups using other methods (i.e., not based on statistical channel features, e.g., randomly, based on a first come first serve basis, or other methods). The maximum pilot symbol overhead is selected for each resource block (or group). Such a case may be implemented, for example, when the number of users corresponding to each quantized channel condition is small and/or where the number of available pilot patterns is large enough, so that it is unlikely that users requiring the highest pilot overhead are scheduled in each resource block.

In yet another case, the pilot sequence pattern length is selected independently for each user terminal. User terminals are divided into groups based on the same pilot sequence pattern lengths.

In another case, the pilot sequence pattern length is selected independently for each user terminal. User terminals are divided into groups using other methods (e.g., not based on pilot sequence pattern lengths and/or not based on statistical channel features). The maximum pilot symbol overhead is selected for each resource block (or group).

Referring now back to FIG. 2, at 208, multi-user wireless communication unit 102 uses receiver/transmitter 106 to transmit instructions to all members of one or more pilot pattern groups (e.g., of each group) to use the common selected pilot pattern.

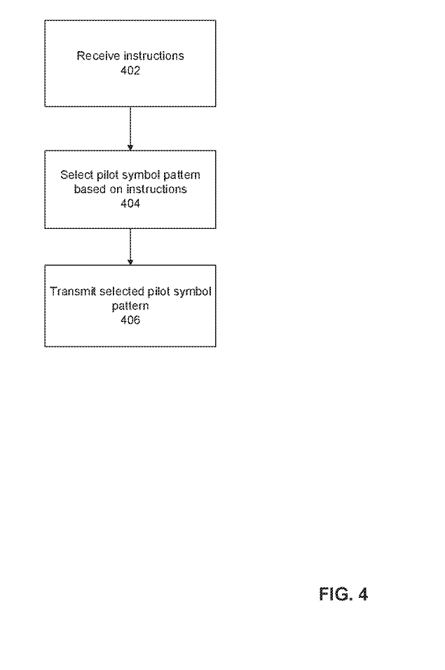

Reference is now made to FIG. 4, which is a flowchart of a method implemented by user terminal 104 (described with reference to FIG. 1), in response to receiving the instructions to use the selected pilot pattern from multi-user wireless communication unit 102, in accordance with some embodiments of the present invention. The acts of method FIG. 4 are performed by each user terminal 104 communicating with multi-user wireless communication unit 102. For clarity, the method of FIG. 4 is described with reference to one of the user terminals 104.

At 402, instructions transmitted from multi-user wireless communication unit 102 are received by receiver/transmitter 116 of user terminals 104.

At 404, code stored in memory 122 executed by processing unit 120 of user terminal 104 includes instructions to select, based on the received instructions, a pilot symbol pattern. The pilot symbol pattern may be selected from pilot symbol patterns stored in pilot symbol repository 122A (stored in data repository 122, on a remote device, on a remote server, and/or other locations). The selected pilot symbol pattern may be obtained in other ways, for example, transmitted from multi-user wireless communication unit 102.

The selected pilot symbol pattern represents the common pilot symbol pattern used by all user terminals 104 belonging to the same pilot pattern group (or same resource block).

At 406, user terminal 104 transmits the pilot symbols according to the selected pilot symbol pattern to multi-user wireless communication unit 102.

Referring now back to FIG. 2, at 210, one or more of blocks 202-208 are iterated, to dynamically select new pilot symbol patterns according to changing channel conditions. The state of the channel may be monitored based on the statistical channel features. Changes in the values of one or more of the statistical channel features (e.g., according to a change tolerance requirement), such as due to changing channel conditions (e.g., rain, user moving, interference sources, noise generating sources), may trigger a new assignment of pilot symbol patterns.

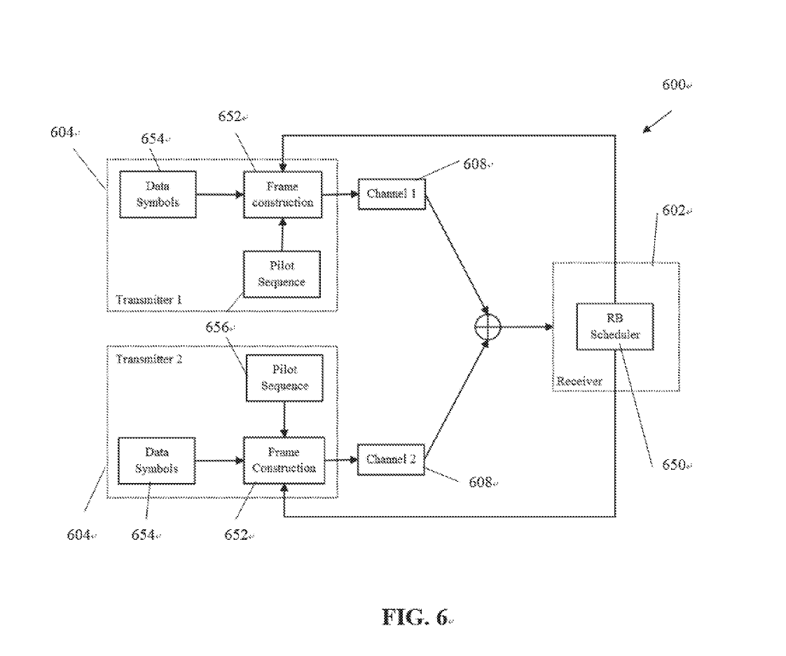

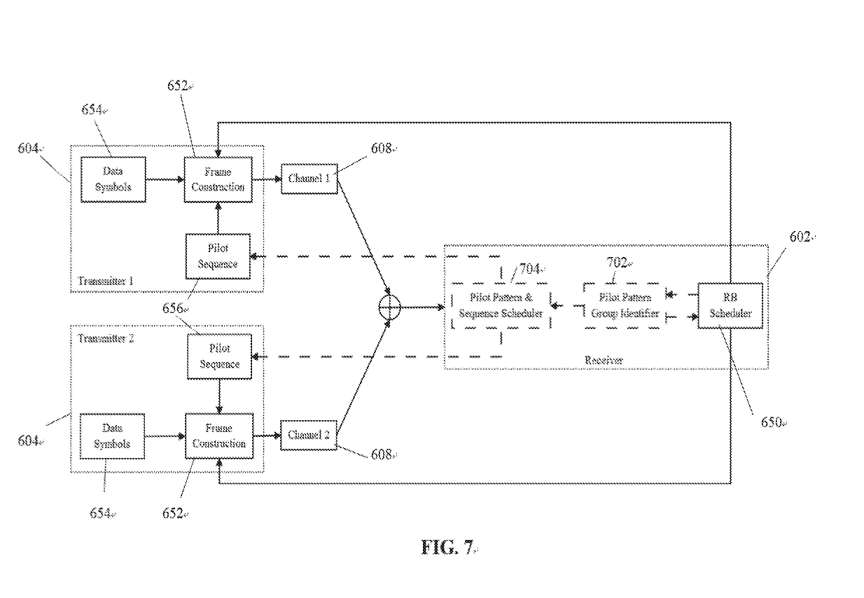

Reference is now made to FIG. 6, which is a block diagram depicting exemplary dataflow in a wireless communication system that does not yet include the systems and/or methods described herein, in accordance with some embodiments of the present invention. The dataflow described with reference to FIG. 6 provides a basis for understanding the dataflow of the systems and/or methods described herein, as will be discussed with reference to FIG. 7.

Wireless system 600 includes user terminals 604 that include transmitters that wirelessly communicate with a receiver of a multi-user wireless communication unit 602 over channels 608, such as a base station. Both user terminals 604 are allocated to the same resource block. A resource scheduler 650 (e.g., code executed by a processing unit of receiver 602) selects the resource block and assigns user terminals 604. Each user terminal 604 includes a frame construction module 652 (e.g., code executed by a processing unit of user terminal 604) that generates the content of the frame for transmission over respective channel 608. The frame includes data symbols 654 (e.g., user data such as voice data and/or application data) and pilot sequence 656. Both user terminals 604 use the same pattern for their respective pilot sequence 656.

Reference is now made to FIG. 7, which is a block diagram based on FIG. 6, depicting exemplary dataflow in a wireless communication system that includes the systems and/or methods described herein, in accordance with some embodiments of the present invention. Resource block scheduler 650 accesses pilot pattern group identifier module 702 that performs scheduling of user terminals 604 to resource blocks according to statistical features of respective channels 608, as described herein. Module 702 assigns each user terminal 604 to a pilot pattern group, as described herein. Pilot pattern and sequence scheduler module 704 receives the pilot pattern group from module 702 and selects the pilot pattern for each resource block, and assigns the pilot sequence to each user terminal 604 according to the scheduled resource block that the user terminal 604 belongs to, as described herein. The selected pilot pattern is transmitted to each user terminal 604 for implementation during wireless communication with receiver 602, as described herein.

Various embodiments and aspects of the present invention as delineated hereinabove and as claimed in the claims section below find calculated support in the following example, which illustrates enhancement of the spectral efficiency of a multi-user wireless system, optionally a multi-input multi-output (MIMO) system that allocates resources to user terminals (i.e., pilot sequence overhead associated with resource blocks) based on statistical channel features of the respective channels used by the user terminals.

Inventors performed calculations of the gain in spectral efficiency that may be achieved using the systems and/or methods described herein. The calculations are performed for the uplink channel in an OFDM-based massive MU-MIMO wireless system environment. Each resource block (RB) includes N_{SC}=128 subcarriers in N_{S}=14 consecutive OFDM symbols (i.e., the number N_{RE} of resource elements in one RB is N_{RE}=128*14=1792). The calculations are based on the total number Uₘₐₓ active users equal to Uₘₐₓ=500. The number Nₜₓ of base station (BS) transmitting antennas is set to Nₜₓ=200. Based on the number of BS antennas, the maximum number Uₘₐₓ^{RB} of users that may be spatially multiplexed on the same RB (while still having the massive MIMO effect) is limited to

$${U}_{max}^{RB} = \frac{{N}_{tx}}{10} = 20.$$

For the sake of simplicity, the calculations are based on the assumption that all the users have the same data rate requirements, the same channel spatial correlation matrix and the same average signal to noise ratio (SNR) over the entire bandwidth. These assumption allow gains due to pilot pattern adaptation to be dissociated from the gain due to optimal scheduling.

Let Tₛ=66.7 μs (microseconds) be the duration of the OFDM symbol and Δf=15 kHz (kilohertz) be the subcarrier frequency separation. The calculations are based on the assumption that each user u (u∈{1,2, . . . , Uₘₐₓ}) pilot pattern is a periodic structure of length N_{p,u}. The pilot sequences of the different Uₘₐₓ^{RB} users scheduled in the same RB may be made orthogonal by shifting their patterns in time with respect to one another while avoiding overlapping of data and pilot symbols. A total per-RB channel training overhead Nₚ equal to Nₚ=N_{p,u}×Uₘₐₓ^{RB} is obtained. The calculations are further based on assumption that the number N_{p,u} of pilot symbols needed to obtain a sufficiently good channel estimate during a given RB should satisfy:

N_{p,u}≥4N_{RE}TₛΔƒƒ_{D,u}τ_{max,u},

where ƒ_{D,u} denotes the Doppler frequency shift associated with user u and τ_{max,u} denotes the corresponding delay spread. The calculations are further based on the assumption that for uƒ_{D,u} is uniformly distributed over the interval [0,120] Hz (hertz) and that τ_{max,u}is uniformly distributed over the interval [0,10] μs.

The calculations compare performance using the systems and/or methods described herein to a conventional pilot selection scheme, for example, in which the pilot length N_{p,u}^{conventional} is selected according to the user terminal with the worst possible channel conditions, N_{p,u}^{conventional}=[4N_{RE}TₛΔƒ×120×10×10⁻⁶]=9, ∀u∈{1,2, . . . , Uₘₐₓ}. The total number of pilot symbols per RB in the conventional scheme is:

Nₚ^{conventional}=Uₘₐₓ^{RB}┌4N_{RE}TₛΔƒ×120×10×10⁻⁶┐=180.

Based on the systems and/or methods described herein, the Doppler shift ƒ_{D,u} and the delay spread T_{max,u} of each user u∈{1,2, . . . , Uₘₐₓ} are quantized such that user terminals are divided into groups. The calculations are based on a scalar uniform quantization of both ƒ_{D,u} and τ_{max,u} that results in ƒ_{D,u}^{quantized}∈{12,36,60,84,108} Hz and τ_{max,u}^{quantized}∈{1,3,5,7,9} μs, ∀u∈{1,2, . . . , Uₘₐₓ}.

Note that the quantization results in a number Gₘₐₓ of pilot pattern groups given by Gₘₐₓ=25 . Moreover, since the values of ƒ_{D,u} and τ_{max,u} are uniformly distributed over their respective intervals, the average number of users in each group will be equal to

$$\frac{{U}_{max}}{{G}_{max}} = \frac{500}{25} = 20.$$

The number N_{p,u}^{adaptive} of pilot symbols for each user u∈{1,2, . . . , Uₘₐₓ} and the corresponding overall per-RB training overhead Nₚ^{adaptive} is:

N_{p,u}^{adaptive}=┌4N_{RE}TₛΔƒƒ_{D,u}^{quantized}τ_{max,u}^{quantized}┐, and Nₚ^{adaptive}=N_{p,u}^{adaptive}×Uₘₐₓ^{RB}.

The average number of pilot symbols per user that may be obtained based on the systems and/or methods described herein is denoted by:

$$E [ {N}_{p}^{adaptive} ] = \frac{1}{{G}_{max}} {Σ}_{g = 1}^{{G}_{max}} ⌈ 4 {N}_{RE} {T}_{s} Δ f {f}_{D , g}^{quantized} {τ}_{max , g}^{quantized} ⌉ \times {U}_{max}^{RB} \approx 54.$$

The decrease in average pilot overheat per RB that may be achieved by the systems and/or methods described herein relative to a conventional scheme is represented by:

$$\frac{{N}_{p}^{conventional} - {N}_{p}^{adaptive}}{{N}_{p}^{conventional}} \approx 70 \% .$$

The increase in average spectral efficiency that may be achieved by the systems and/or methods described herein relative to a conventional scheme is represented by:

$$\frac{( {N}_{RE} - {N}_{p}^{adaptive} ) - ( {N}_{RE} - {N}_{p}^{conventional} )}{{N}_{RE} - {N}_{p}^{conventional}} \approx 7.82 \%$$

It is noted that higher gains in spectral efficiency may be achieved in situations with larger number of users having more diverse channel conditions and/or with larger values of Uₘₐₓ^{RB}.

The above described calculations were based on the assumption that user terminal scheduling has no effect on the overall performance. The calculations now described are based on the assumptions that users are not equivalent from a scheduling point of view. The calculations are based on the assumption that the baseline scheduling scheme used is the semi-orthogonal user group (SUS) algorithm described by T. Yoo, and A. Goldsmith, “On the Optimality of Multiantenna Broadcast Scheduling Using Zero-Forcing Beamforming,” IEEE Journal on Selected Areas in Communications, vol. 24, no. 3, March 2006. Using the described scheduler, the maximum possible sum rate that may be achieved on a given RB when scheduled on this RB a number Uₘₐₓ^{RB} of users out of a pool of Uₘₐₓ>Uₘₐₓ^{RB} users assuming at the signal-to-noise ratio level SNR is given by:

$${C}_{genie}^{conventional} = \frac{1}{{G}_{max}} {Σ}_{g = 1}^{{G}_{max}} {U}_{max}^{RB} log ( 1 + \frac{SNR}{{U}_{max}^{RB}} log ( {U}_{max} ) ) .$$

Factor log(Uₘₐₓ) denotes the multiuser-diversity gain. The subscript genie denotes that the capacity is actually an upper bound that is obtained based on the assumption that the base station (BS) has perfect channel state information (CSI) about all the users' channels. In practice, the sum rate C^{conventional} may be smaller due to channel learning overhead and may be calculated by the relationship:

$${C}^{conventional} = \frac{{U}_{max}^{RB}}{{G}_{max}} {\sum }_{g = 1}^{{G}_{max}} \frac{{N}_{RE} - {N}_{p}^{scheduling} - {N}_{p}^{conventional}}{{N}_{RE}} log ( 1 + \frac{SNR}{{U}_{max}^{RB}} log ( {U}_{max} - ( g - 1 ) {U}_{max}^{RB} ) )$$

Nₚ^{scheduling} denotes the channel learning overhead (measured in pilot symbols) needed to obtain the users' channel estimates on all the available RBs (Gₘₐₓ=25 in the present example) for the scheduler to function properly, and represents the additional overhead needed for scheduling as opposed to the case where only the channel estimate for a single RB is needed. It is noted that using

$$\frac{{U}_{max}}{{U}_{max}^{RB}} {N}_{p}^{conventional} = {G}_{max} {N}_{p}^{conventional}$$

instead of Nₚ^{conventional} more provides more precise channel estimates on all the Gₘₐₓ RBs for Uₘₐₓ users instead of Uₘₐₓ users, i.e. Nₚ^{scheduling}=(Gₘₐₓ=1)Nₚ^{conventional}. However, scheduling may yield almost the same multiuser diversity gain while using less precise CSI. It may be sufficient to use Nₚ^{scheduling}≈Uₘₐₓ. More precisely, Nₚ^{scheduling}=Uₘₐₓ−Uₘₐₓ^{RB}) in the present example. Finally, the term Uₘₐₓ−(g−1)Uₘₐₓ^{RB} reflects the fact that once the first chosen Uₘₐₓ^{RB} are scheduled on some RB, the multiuser diversity gain for the next group of Uₘₐₓ^{RB} users will be log(Uₘₐₓ−(g−1)Uₘₐₓ^{RB}) instead of log(Uₘₐₓ).

The calculated theoretical multiuser diversity gain is smaller and equal to the number Uₘₐₓ^{RB} of users within each pilot pattern group. However, the overhead, denoted as Nₚ^{scheduling}(g), needed for CSI acquisition for scheduling purposes is smaller since the scheduler would only need CSI on only one RB for the users of each group instead of on all the RBs as is the case for the baseline comparison scheme. For instance, if the scheduling scheme described with reference to K. Huang, J. G. Andrews, and R. W. Heath, “Throughput Scaling of Uplink SDMA with Limited Feedback,” ACSSC, November 2007 is used, then Nₚ^{scheduling}(g) is upper bounded by the number Uₘₐₓ^{RB} of users per group for any 1≤g≤Gₘₐₓ. This leads to a sum rate C^{adaptive} given by:

$$. {C}^{adaptive} = \frac{{U}_{max}^{RB}}{{G}_{max}} {Σ}_{g = 1}^{{G}_{max}} \frac{{N}_{RE} - {N}_{p}^{scheduling} ( g ) - {N}_{p}^{adaptive} ( g )}{{N}_{RE}} log ( 1 + \frac{SNR}{{U}_{max}^{RB}} log ( {U}_{max}^{RB} ) )$$

Assuming SNR=10 dB, E[Nₚ^{adaptive}]=54 and Nₚ^{conventional}=180, C_{conventional} =24.13 b/s Hz and C^{adaptive}=25.62 b/s/Hz, which correspond to a gain in the average spectral efficiency equal to

$$\frac{{C}^{adaptive} - {C}^{conventional}}{{C}^{conventional}} \approx 7.73 \% .$$

Note that the resulting value 7.73% is very close to the maximal gain in spectral efficiency 7.82% (discussed above) that was obtained by ignoring the effect of grouping on the performance of scheduling. It is noted that the calculated result is rather conservative since the baseline scheduling scheme described by Huang et al. only works on reciprocal uplink/downlink channels so that more CSI overhead would in practice be needed on non-reciprocal channels.

In another example, inventors compared a baseline method in which the pilot pattern is fixed to densest pattern among all the users, to the pilot selection according to the systems and/or methods described herein based on selecting the pilot pattern in each RB as the densest pattern among the lighter pilot patterns requested by each user in that RB. In the baseline method and the method based on the systems and/or methods described herein an exhaustive approach is used, where all possible user scheduling settings are considered, and the corresponding sum rate is computed.

The simulated scenario includes 10 users, 5 of which may be spatially multiplexed in a resource block. Therefore, two resource blocks are sufficient to allocate all the users in the system. Each RB is assumed to include 128 single carriers, and 14 time slots. The BS is assumed to apply zero forcing receive beamforming in each RB. The sum-rate in a resource block may be expressed by

$$\frac{1}{{N}_{RE}} {Σ}_{k} {Σ}_{f} {Σ}_{t} log ( 1 + {SNR}_{k} ( f , t ) ) ,$$

where SNRₖ(ƒ, t) denotes the received SNR per resource element (ƒ,t) for user k scheduled in that RB.

In the comparison pilot allocation method (i.e., not using the systems and/or methods described herein), based on the worst case Doppler frequency shift and delay spread, the scheduler may decide to allocate the 5 users per block such that the overall (genie-aided) sum-rate is maximized. Based on the systems and/or methods described herein, each RB is assigned a pilot pattern dependent on the worst case Doppler frequency shift and delay spread within the RB. In the simulation, it assumed that half the users are affected by a Doppler frequency shift of ƒ_{D,2}=120 Hz, whereas the other half are affected by ƒ_{D,1} which we vary from 10 Hz to 120 Hz. It is assumed that the number of pilot symbols needed per RB for the worst-case Doppler frequency shift is equal to 180 while the number of required pilot symbols at smaller Doppler frequency shifts is proportionally smaller than this maximum value.

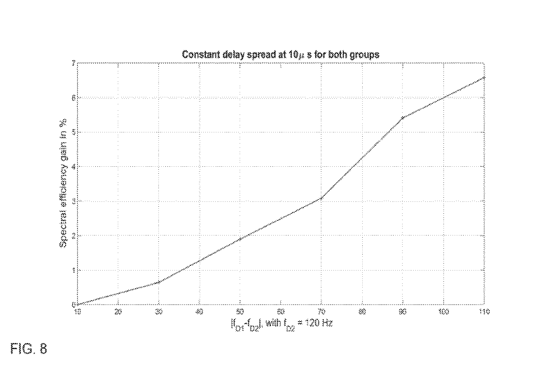

Reference is now made to FIG. 8, which is a graph of results obtained from the calculated comparison simulation, in accordance with some embodiments of the present invention. The graph shows that the spectral efficiency gain is represented as a function of the difference between ƒ_{D,1} and ƒ_{D,2} .The graph shows that the gain is more significant for a higher difference of the Doppler frequency between the two sets of users. For example, for two sets of users, one moving at 3 km/h (kilometers per hour), the other moving at 120 km/h, at a frequency of 1 GHz (gigahertz) the gain obtained using the systems and/or methods described herein is about 6.6%.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant wireless communication systems will be developed and the scope of the terms pilot pattern and resource blocks are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A first apparatus used in a wireless network for scheduling of resources to user terminals, comprising:
a receiver adapted to receive wirelessly a plurality of transmission signals from a plurality of user terminals over a plurality of channels; and
a processing unit adapted to:
assigning at least one of said plurality of user terminals to a resource block from a plurality of resource blocks according to at least one statistical channel feature of the respective channel from said plurality of channels which is used by respective said user terminal.

2. The apparatus of claim 1, wherein said assigning comprises:
selecting for each one of said plurality of user terminals a pilot symbol pattern from a plurality of pilot symbol patterns according to respective said statistical channel features, the pilot symbol pattern entailing a corresponding pilot symbol overhead equal to the number of pilot symbols in the selected pilot symbol patterns;
assigning each one of said plurality of user terminals to a resource block from said plurality of resource blocks according to a plurality of criteria, including at least the minimization of said pilot symbol overhead;
setting said pilot symbol pattern for each one of said plurality of resource blocks as the pilot symbol pattern with maximum said pilot symbol overhead among the pilot symbol patterns selected for respective user terminals which are assigned to the resource block from said plurality of user terminals.

3. The apparatus of claims 1, wherein by said selecting, for each one of said plurality of user terminals, the pilot symbol pattern from a plurality of pilot symbol patterns, said plurality of user terminals are divided into a plurality of pilot pattern groups according to respective said statistical channel features; further comprising allocating a common pilot pattern to all members of each said plurality of pilot pattern groups.

4. The apparatus of claim 1, wherein assigning said plurality of user terminals to a resource block from said plurality of resource blocks is such that respective user terminals in the same resource block are selected from the same said pilot pattern group and have the same said pilot symbol pattern.

5. The apparatus of claim 3, wherein the said division of user terminals to a plurality of said pilot pattern groups is done by quantizing at least one of said statistical channel features of said respective channels which are used by said user terminals.

6. The apparatus of claim 3, wherein said division of user terminals to a plurality of said pilot pattern groups and said quantization of statistical channel features is done according to the number of said resource blocks which are available for wireless transmission.

7. The apparatus of claim 3, further comprising a transmitter adapted to transmit instructions to all members of one of said plurality of pilot pattern groups to use a common pilot pattern.

8. The apparatus of claim 3, wherein said common pilot pattern is an OFDM pilot pattern and the said resource block is an OFDM resource block.

9. The apparatus of claim 1, wherein each one of said plurality of user terminals transmits one of said plurality of transmission signals via a single antenna or multiple antennas.

10. The apparatus of claim 1, wherein said at least one statistical channel feature comprises at least one element of a list consisting of channel delay spread, channel maximum Doppler shift, channel spatial covariance matrix, channel matrix rank, channel average signal-to-noise ratio (SNR), and the history of ACK/NACK messages.

11. A method for performing resource assignment to user terminals, comprising:
wirelessly receiving a plurality of transmission signals from a plurality of user terminals over a plurality of channels; and
assigning each one of said plurality of user terminals to a resource block from a plurality of resource blocks according to at least one statistical channel feature of a respective channel used by respective said user terminal from said plurality of channels.

12. The method of claim 11, wherein said assigning comprises:
selecting for each one of said plurality of user terminals a pilot symbol pattern from a plurality of pilot symbol patterns according to respective said statistical channel features, the pilot symbol pattern entailing a corresponding pilot symbol overhead equal to the number of pilot symbols in the selected pilot symbol patterns;
assigning each one of said plurality of user terminals to a resource block from said plurality of resource blocks according to a plurality of criteria, including at least the minimization of said pilot symbol overhead;
setting said pilot symbol pattern for each one of said plurality of resource blocks as the pilot symbol pattern with maximum said pilot symbol overhead among the pilot symbol patterns selected for respective user terminals which are assigned to the resource block from said plurality of user terminals.

13. The method of claims 11, wherein by said selecting, for each one of said plurality of user terminals, the pilot symbol pattern from a plurality of pilot symbol patterns, said plurality of user terminals are divided into a plurality of pilot pattern groups according to respective said statistical channel features; further comprising allocating a common pilot pattern to all members of each said plurality of pilot pattern groups.

14. The method of claim 11, wherein assigning said plurality of user terminals to a resource block from said plurality of resource blocks is such that respective user terminals in the same resource block are selected from the same said pilot pattern group and have the same said pilot symbol pattern.

15. A second apparatus for one or more of transmitting and receiving signals in a wireless network, the apparatus comprising:
a look-up table storing a plurality of pilot symbol patterns;
a receiver adapted to receive instructions from a first apparatus;
a processing unit configured to select, based on the received instructions, a pilot symbol pattern from said plurality of stored pilot symbol patterns, said selected pilot symbol pattern being a common pilot symbol pattern used by a plurality of second apparatuses belonging to a pilot pattern group; and
a transmitter configured to transmit to the first apparatus pilot symbols according to the selected pilot symbol pattern.
